(19) United States
(12) Patent Application Publication
(10) Pub. No.: US 2007/0044332 A1
(43) Pub. Date: Mar. 1, 2007

(54) Laser leveler with rotatable top section

(76) Inventors: Billy Yung, Chai Wan (HK); Benny Tang, Chai Wan (HK)

Correspondence Address: SHELDON MAK ROSE & ANDERSON PC, 225 SOUTH LAKE AVENUE, 9TH FLOOR, PASADENA, CA, 91101, US

(21) Appl. No.: 11/213,263

(22) Filed: Aug. 26, 2005

(51) Int. Cl. G01C 15/00

(52) U.S. Cl. 33/286

(57) ABSTRACT

A laser leveler comprises a multiplicity of laser generators. One of the laser levelers is disposed in a top section which is rotatable with respect to a base section. The laser generator within the top section is rotatable through an angle of 90° between the horizontal and the vertical. A second laser generator is disposed within a midsection, located between the base and the top section. The laser generator within the midsection is capable of generating a vertical laser beam.

### BACKGROUND OF THE INVENTION

Laser levelers capable of generating a visible, low energy laser beam are becoming quite popular in the construction arts as valuable tools to define construction lines along vertical and horizontal surfaces. For example, laser levelers are used to define perfectly vertical plumb lines for walls, riser pipes and ducts and for the placement of perfectly horizontal ledges, shelves, pipes and ducts.

However the laser levelers of the prior art are deficient in several respects which reduces their over all efficiency to the user.

Accordingly, there is a need for an improved laser leveler which markedly increases the tool's capabilities and efficiency over similar laser levelers of the prior art.

### SUMMARY OF THE INVENTION

The invention satisfies this need. The invention is a laser leveler comprising a base and a top section which is rotatable with respect to the base. Disclosed within the top section is at least one laser generator which is rotatable between the horizontal and the vertical. In one embodiment of this aspect of the invention, an additional laser generator can be disposed within a midsection for generating a vertical laser beam. In this embodiment of the invention, the laser beams generated by the top section laser generator and the midsection laser generator can be used to form a cross against a vertical surface, such as a wall.

### DRAWINGS

These and other features, aspects and advantages of the present invention will become better understood with reference to the following description, appended claims and accompanying drawings where:

FIG. 1 is a perspective view of a laser leveler having features of the invention;

FIG. 2 is a plan view of the laser leveler illustrated in FIG. 1;

FIG. 2A is a cross-sectional detail view of a foot useful in the laser lever illustrated in FIG. 1;

FIG. 3 is a perspective view of the laser leveler illustrated in FIG. 1, shown with its top cover removed;

FIG. 4 is a perspective view of a top section of the laser leveler illustrated in FIG. 1.

FIG. 5 is a perspective view of a midsection of the laser leveler illustrated in FIG. 1.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

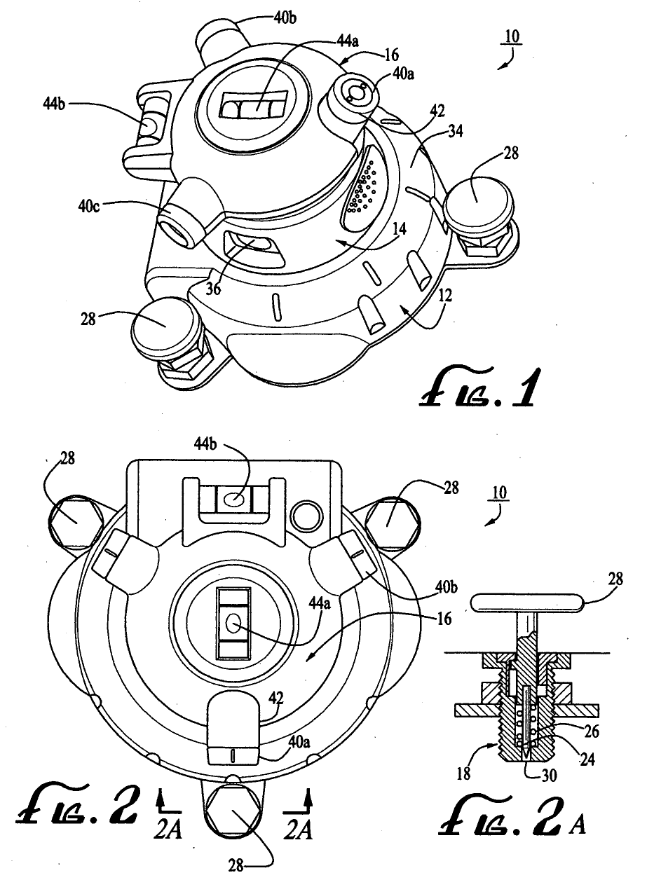

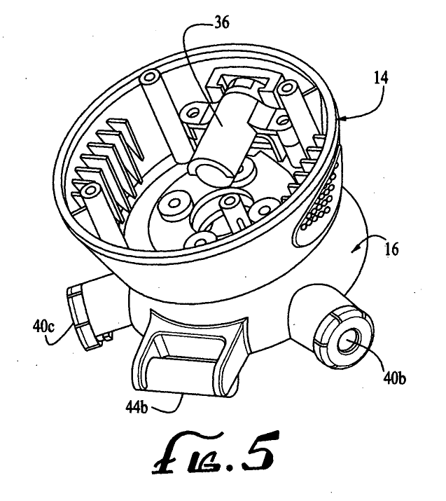

The invention is a laser leveler 10. In the embodiment illustrated in FIGS. 1-5, the laser leveler 10 comprises a base 12, a midsection 14 and a top section 16. The base 12 and the midsection 14 are connected to one another such that the midsection 14 can be rotated about the base 12, either clockwise or counterclockwise, through an arc of 180°. The midsection 14 and the top section 16 are also connected to one another such that the top section 16 can be rotated with respect to the midsection 14, either clockwise or counterclockwise, through an arc of 180°.

The base 12 comprises a plurality of adjustable feet 18, a battery compartment 20 and an on/off switch 22.

The height of each foot 18 is vertically adjustable so as to be able to properly level the laser leveler 10.

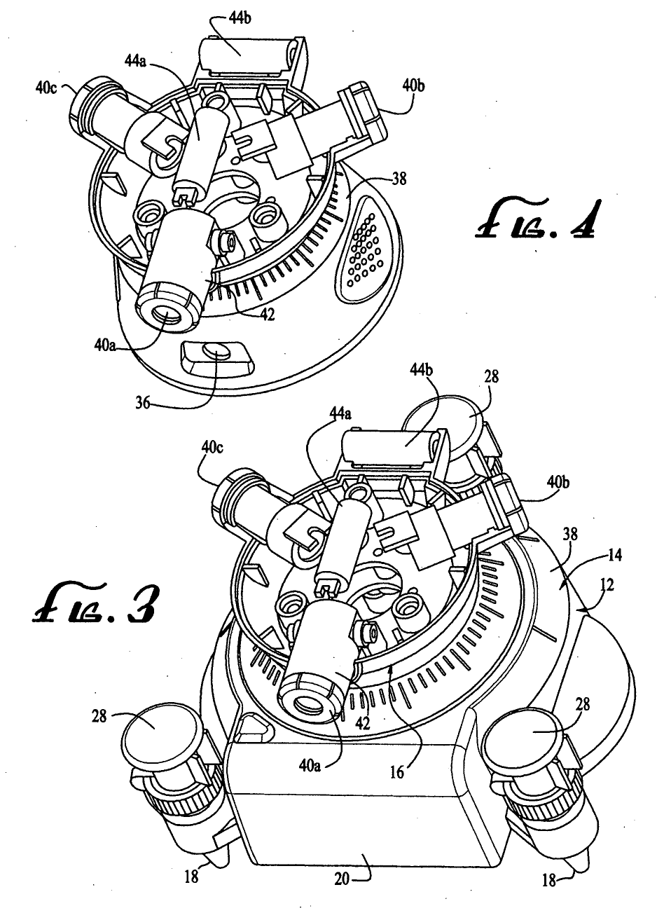

As illustrated in FIG. 2A, each foot 18 preferably comprises a needle 24, an internal spring 26 and a plunger 28 within the foot 18. These three components are configured such that the pressing of the plunger 28 causes the needle 24 to extend outwardly from the interior of the foot 18, through a small hole 30 in the bottom 32 of the foot 18. The plunger 28 is configured such that, when the needle 24 is extended outwardly from the interior of the foot 18, the needle 24 can be locked in that extended position. The ability to extend the needles 24 allows the laser leveler 10 to be attached against a vertical wall. The spring 26 and the plunger 28 are configured such that releasing the plunger 28 causes the needle 24 to retract back into the foot 18.

The base 12 further comprises a ruled band 34 disposed 360° around the base 12. This ruled band 34 typically is marked to show divisions of 30°.

The battery compartment 20 typically is sized and dimensioned to accept and retain two AA batteries, capable of generating three volts of direct current power.

The midsection 14 comprises a midsection laser diode 36 capable of generating a vertical laser beam. The midsection laser diode 36 can be used to conveniently generate an upwardly directed “plumb” line when the laser leveler 10 is disposed on a horizontal surface.

The midsection 14 also preferably comprises a ruled band 38 extending 360° around the midsection 14. Typically, the ruled band 38 is divided into 5° increments.

The top section 16 comprises three horizontal laser diodes 40a, 40b and 40c, each capable of generating a horizontal laser beam. Typically, each horizontal laser diode 40a, 40b and 40c is disposed 120° away from adjoining horizontal laser diodes 40a, 40b and 40c.

Preferably, the lens head of the forwardmost horizontal laser diode 40a can be rotated through an arc of 90° to generate either a horizontal or a vertical beam. The forwardmost horizontal laser diode 40a is disposed within an arm 42 which can be pivoted through an arc up to a maximum of 45°, thereby allowing a laser beam generated from the forwardmost horizontal laser diode 40a to be rotatable through an arc of up to 45°.

The top section 16 further comprises a pair of bubble-style level indicators 44aand 44b, both of which are viewable from above the laser leveler 10 and reside in the same plane. One of the level indicators (44a) is a horizontal axis (X-axis) indicator adapted to be capable of facilitating the adjustment of the feet 18 so as to place the laser beams 40a, 40b and 40c in the same horizontal plane. The other of the level indicators (44b) is a vertical axis (Y-axis) indicator provided in the top section 16 to facilitate the adjustment of the feet 18 to place the laser beam 40a, 40b and 40c in the same vertical plane.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A laser leveler comprising:
(a) a base;
(b) a top section comprising at least one top section laser generators, the at least one laser generator being rotatable upwardly through an angle of about 90°.

2. The laser leveler of claim 1 wherein the at least one laser generator is disposed within an arm which is pivotable through an arc of up to 45°.

3. The laser leveler or claim 1 when the top section comprises three top section laser generators, each spaced apart from adjoining laser generators by about 120°.

4. The laser leveler of claim 1 further comprising a midsection having a midsection laser generator, capable of generating a vertical laser beam when the laser leveler is disposed on a horizontal surface.

5. The laser leveler of claim 1 wherein the midsection is rotatable with respect to the base, either clockwise or counter-clockwise, through an angle of at least 180°.

6. The laser leveler of claim 1 wherein the top section is rotatable with respect to the midsection, either clockwise or counter-clockwise, through an angle of at least 180°.

7. The laser leveler of claim 1 further comprising a pair of level indicators, one of the level indicators being adapted to facilitate the leveling of the laser leveler when the laser leveler is disposed on a generally horizontal surface, and one of the level indicators being adapted to facilitate the leveling of the laser leveler when the laser leveler is disposed on a generally vertical surface.

8. The laser leveler of claim 1 wherein the base comprises at least three feet, at least one of the feet comprising an internally mounted needle slidably disposed within the foot and adapted to alternatively extend outwardly beyond the foot in an extended position or retract within the foot in a retracted position.

9. A laser leveler comprising a base having at least three feet, at least one of the feet comprising an internally mounted needle slidably disposed within the foot and adapted to alternatively extend outwardly beyond the foot in an extended position or retracted within the foot in a retracted position.
